(19) United States
(12) Patent Application Publication
(10) Pub. No.: US 2010/0171230 A1
(43) Pub. Date: Jul. 8, 2010

(54) Method for Production of Granular Sodium Percarbonate

(75) Inventors: Stefan Leininger, Langenselbold (DE); Michael Scheibe, Rheinfelden (DE); Lothar Kaiser, Rheinfelden (DE); Bertram Trautvetter, Rheinfelden (DE); Waldemar Hessberger, Alzenau (DE); Marcel Verduyn, Zevenhuizen (NL); Holger Pitsch, Mainhausen (DE); Harald Jakob, Hasselroth (DE)

Correspondence Address: LAW OFFICE OF MICHAEL A. SANZO, LLC, 15400 CALHOUN DR., SUITE 125, ROCKVILLE, MD, 20855, US

(73) Assignee: EVONIK DEGUSSA GMBH, Essen (DE)

(21) Appl. No.: 12/442,865

(22) PCT Filed: Jul. 17, 2007
(86) PCT No.: PCT/EP2007/057390

§ 371 Date: Dec. 28, 2009

(30) Foreign Application Priority Data
Sep. 28, 2006 (EP) 06121390.6

(51) Int. Cl. B29B 9/10

(52) U.S. Cl. 264/5

(57) ABSTRACT

The process for producing granular sodium percarbonate by fluidized bed buildup granulation comprises the spraying of an aqueous solution of hydrogen peroxide and of an aqueous solution of sodium carbonate with at least one multisubstance nozzle with external mixing into a fluidized bed comprising sodium percarbonate particles and simultaneously evaporating water, and is characterized in that the solution of sodium carbonate additionally comprises sodium carbonate and/or sodium percarbonate in suspended form and is passed through a dispersing apparatus for dispersion of solids before being fed to the multisubstance nozzle.

The process allows the blockage of the multisubstance nozzle to be avoided and sodium percarbonate dust to be recycled from the offgas stream of the fluidized bed into the granulation.

The invention provides a process for producing granular sodium percarbonate by fluidized bed buildup granulation, in which sodium carbonate and/or sodium percarbonate can be fed to the spray nozzles in suspended form without there being any blockage of the nozzles.

Sodium percarbonate is increasingly being used as a bleaching component in detergents and cleaning products. For this application, sodium percarbonate must have sufficient storage stability in detergent and cleaning product formulations, since there is otherwise an undesired loss of active oxygen and hence of bleaching action in the course of storage of the detergents and cleaning products. Sodium percarbonate is moisture-sensitive and decomposes in detergent and cleaning product formulations under the action of moisture with loss of active oxygen. Sodium percarbonate is therefore typically used in coated form to produce detergents or cleaning products, the coating layer preventing the action of moisture on the coated sodium percarbonate particles. The use of granular sodium percarbonate allows an effective coating layer to be achieved even with small amounts of coating material.

Granular sodium percarbonate with a smooth surface which is particularly suitable for coating can be produced by the fluidized bed buildup granulation process known from WO 95/06615. In this process, an aqueous solution of hydrogen peroxide and an aqueous solution of sodium carbonate are sprayed through a multisubstance nozzle with external mixing into a fluidized bed comprising sodium percarbonate particles, and water is simultaneously evaporated. In the spray cone of the multisubstance nozzle, droplets of a sodium percarbonate solution which is generally oversaturated are generated by mixing the hydrogen peroxide solution and the sodium carbonate solution. In the fluidized bed, these droplets strike sodium percarbonate particles on which sodium percarbonate is deposited from the solution, and from whose surface the water introduced with the aqueous solutions is evaporated by the gas supplied to fluidize the fluidized bed. However, the process has the disadvantage that relatively large amounts of water have to be evaporated. Moreover, as a result of the abrasion of particles in the fluidized bed, and as a result of undesired drying of droplets before they meet sodium percarbonate particles, sodium percarbonate dust is obtained, which is discharged from the fluidized bed with the fluidizing gas.

The sodium percarbonate dust which is obtained with the offgas from the fluidized bed does not meet the requirements for use in detergents and has therefore to date been recycled into the production process by adding it in the preparation of the sodium carbonate solution. Sodium percarbonate dust from other process steps, such as a coating step or a pneumatic delivery of sodium percarbonate particles, can also be recycled into the production process in the same way. However, a large portion of the hydrogen peroxide bound within the sodium percarbonate dust is lost as a result of decomposition in the alkaline sodium carbonate solution.

EP 0 787 682 A1 proposes to feed a sodium carbonate suspension to the multisubstance nozzle instead of the sodium carbonate solution, in order to reduce the amount of water which has to be evaporated. In addition, it is also possible to feed crystalline sodium percarbonate with the sodium carbonate suspension or the spraying air. However, the process described in EP 0 787 682 A1 has the disadvantage that there is blockage of the nozzles even after a short operating time, as has been found in tests which have been carried out in the context of an opposition to EP 0 787 682 B1 filed at the European Patent Office.

There is therefore a need for a process for producing granular sodium percarbonate by fluidized bed buildup granulation, in which sodium carbonate can also be fed to the spray nozzles in suspended form without there being any blockage of the nozzles. There is likewise a need for recycling of sodium percarbonate dust into the process, in which the hydrogen peroxide bound within the sodium percarbonate is preserved and utilized for the production of the desired granular sodium percarbonate.

It has now been found that these objects can be achieved by a process for producing granular sodium percarbonate by fluidized bed buildup granulation, which comprises the spraying of an aqueous solution of hydrogen peroxide and an aqueous solution of sodium carbonate with at least one multisubstance nozzle with external mixing into a fluidized bed comprising sodium percarbonate particles and simultaneously evaporating water, wherein the solution of sodium carbonate additionally comprises sodium carbonate and/or sodium percarbonate in suspended form and is passed through a dispersing apparatus for dispersion of solids before being fed to the multisubstance nozzle.

In the process according to the invention, an aqueous solution of hydrogen peroxide is used, which preferably has a hydrogen peroxide content in the range from 30 to 75% by weight, more preferably from 40 to 70% by weight. The hydrogen peroxide solution may additionally also comprise additives which stabilize the sodium percarbonate. The stability-enhancing additives used are preferably alkali metal silicates, especially waterglass, magnesium salts, stannates, pyrophosphates, polyphosphates, and chelate complexing agents from the group of the hydroxycarboxylic acids, aminocarboxylic acids, aminophosphonic acids, phosphonocarboxylic acids and hydroxyphosphonic acids, and the alkali metal, ammonium or magnesium salts thereof.

Furthermore, in the process according to the invention, an aqueous solution of sodium carbonate is used, which additionally comprises sodium carbonate, sodium percarbonate or both in suspended form. The amounts of suspended sodium carbonate and/or sodium percarbonate can be selected within wide limits, provided that the suspension remains free-flowing and pumpable. The aqueous solution of sodium carbonate may additionally comprise additives which stabilize the sodium percarbonate, preferably one of the additives mentioned in the preceding paragraph. If the solution comprises suspended sodium percarbonate which originates from a subsequent coating stage or from a pneumatic delivery of coated sodium percarbonate particles, the solution of sodium carbonate may also comprise proportions of the coating materials introduced with this sodium percarbonate.

In the process according to the invention, the aqueous solution of sodium carbonate which additionally comprises sodium carbonate, sodium percarbonate or both in suspended form is passed through a dispersing apparatus for the dispersion of solids before being fed to the spray nozzles. Suitable dispersing apparatus includes all apparatus with which the particles of sodium carbonate and/or sodium percarbonate can be distributed homogeneously in the solution of sodium carbonate, destroying agglomerates of sodium carbonate particles or sodium percarbonate particles. Examples of suitable dispersing apparatus include ultrasound dispersers. However, preference is given to using dispersing apparatus which acts mechanically, for example through impingement forces or shear forces. Particular preference is given to dispersing apparatus in which the suspension is sheared between a rotor element and a stator element. Suitable dispersing apparatus is, for example, the inline dispersing equipment of the Ultra-Turrax® and Dispax® series sold by Ika.

The dispersing apparatus is preferably designed and operated such that it destroys, in the suspension, agglomerates with a diameter which is more than one third of the minimum channel dimension of the multisubstance nozzle used. When the suspension is passed through a central channel of a multisubstance nozzle, the minimum channel dimension is based on the minimum diameter of the central channel. When the suspension is passed through an annular channel of a multisubstance nozzle, the minimum channel dimension is based on the minimum width of the annular gap.

The sodium carbonate solution comprising the suspended particles of sodium carbonate and/or sodium percarbonate is preferably passed continuously through the dispersing apparatus and then fed directly to the multisubstance nozzle. The suspension passed through a dispersing apparatus can also be fed simultaneously to a plurality of multisubstance nozzles.

In a preferred embodiment, solid sodium carbonate and/or solid sodium percarbonate is dispersed in an aqueous solution of sodium carbonate in the dispersing apparatus. In this case, the solid is introduced into the sodium carbonate solution and the solid is dispersed in the solution in the same apparatus. Suitable dispersing apparatus for this embodiment is the inline dispersing equipment of the MHD series sold by Ika.

The sodium carbonate solution may additionally comprise additives which stabilize the sodium percarbonate, in which case it is possible to add the same additives as for the hydrogen peroxide solution.

The hydrogen peroxide solution and the sodium carbonate solution which comprises suspended particles of sodium carbonate and/or sodium percarbonate and has been passed through the dispersing apparatus are both fed to one or more multisubstance nozzles in which they are sprayed through separate channels in the nozzle so as to give rise to external mixing in the spray cone of the nozzle. In this case, preference is given to additionally supplying a propellant gas through a further channel in the nozzle. Suitable multisubstance nozzles with one or two channels for propellant gas are known from WO 95/06615 and EP 0 787 682 A1. The propellant gas used is preferably air.

The flow rates of hydrogen peroxide solution and sodium carbonate solution comprising suspended particles of sodium carbonate and/or sodium percarbonate are preferably selected so as to give rise to a molar ratio of sodium carbonate to hydrogen peroxide in the range of 1:1.4 to 1:1.7 and more preferably 1:1.5 to 1:1.65. The molar ratio is based on the total amount of dissolved and suspended sodium carbonate, but does not include suspended sodium percarbonate. The temperatures of the two solutions are preferably in the range of 20° C. to 70° C.

The hydrogen peroxide solution and sodium carbonate solution comprising suspended particles of sodium carbonate and/or sodium percarbonate are sprayed with the multisubstance nozzle into a fluidized bed comprising sodium percarbonate particles. To this end, the multisubstance nozzles may be arranged above the fluidized bed or within the fluidized bed. The multisubstance nozzles are preferably arranged within the fluidized bed in order to keep the path of the generated droplets to the particles of the fluidized bed short and to prevent spray-drying of the droplets.

The fluidized bed is maintained by the supply of a fluidizing gas which simultaneously also brings about the evaporation of water. The fluidizing gas is supplied to the fluidized bed preferably at a temperature in the range of 120 to 500° C., more preferably 200 to 500° C. and especially 300 to 500° C. The temperature and amount of fluidizing gas are selected such that the amount of water introduced with the solutions can for the most part be evaporated. Preference is given to selecting temperature and amount of fluidizing gas such that a temperature in the range of 40 to 95° C., more preferably 50 to 80° C. and especially 60 to 80° C. is maintained in the fluidized bed.

In the process according to the invention, the spraying into the fluidized bed can be effected continuously or discontinuously. The spraying is preferably effected continuously, and granules are removed continuously from the fluidized bed. Granules are removed from the fluidized bed preferably with a classifying discharge apparatus, with which granules with excessively small particle diameters can be recycled into the fluidized bed.

When the fluidized bed is started up, particles are initially charged as seeds in the fluidized bed, and the solutions are sprayed onto them. For this purpose, preference is given to using sodium percarbonate particles which have a smaller particle size than the granules to be produced. In the case of continuous operation of the fluidized bed, new seeds for the buildup of granules have to be provided continuously in the fluidized bed. This can be done by the generation of seeds by abrasion or particle fracture within the fluidized bed. However, preference is given to externally supply seed material in solid form to the fluidized bed in order to control the nucleation rate and hence the particle size distribution of the granules obtained.

During the operation of the fluidized bed, fine particles of sodium percarbonate are discharged in the form of dust from the fluidized bed with the fluidizing gas. These particles can be separated from the offgas stream of the fluidized bed with suitable separating apparatus, for example scrubbers, filters or cyclones. Preference is given to removing these particles from the offgas stream of the fluidized bed in solid form as dust and to feeding the removed dust completely or partially to the dispersing apparatus and dispersing it in the sodium carbonate solution which is fed to the multisubstance nozzle.

The process according to the invention has the advantage over the process known from EP 0 787 682 A1 that it can be operated over a long period without there being any blockage of the multisubstance nozzle. Moreover, compared to the process known from EP 0 787 682 A1, more homogeneous spraying of the sodium carbonate solution comprising particles is achieved, since no particles get stuck in the nozzle orifice and lead to inhomogeneous distributions in the spray cone. This has the effect that virtually full conversion to sodium percarbonate can be achieved with a lower excess of hydrogen peroxide.

In the embodiment in which dust removed from the offgas stream of the fluidized bed is recycled into the dispersing apparatus, the process according to the invention enables recycling of the sodium percarbonate dust into the process without loss of the hydrogen peroxide bound therein. This makes it possible to convert a greater amount of hydrogen peroxide used to saleable granular sodium percarbonate of homogeneous quality. The recycling of the sodium percarbonate dust does not have an adverse effect on the quality of the granular sodium percarbonate obtained.

### EXAMPLES

### Example 1

Spraying of a sodium carbonate solution comprising suspended sodium percarbonate particles with and without a dispersing apparatus.

300 l/h of a 30% by weight soda solution were fed via an inline MHD 2000/5 dispersing machine from IKA to a Schlick 0/56 S3 three-substance nozzle and sprayed without supply of propellant gas. In the dispersing machine, 80 to 150 kg/h of sodium percarbonate dust with a mean particle size of 45 μm were dispersed in the soda solution with a dpuble-row rotor-stator dispersing tool with a tooth gap width of 3 mm. The spray nozzle was operated without blockages over a period of 4 h and generated a homogeneous spray cone.

In a comparative test, a non-dispersing suspending tool was used instead of the dispersing tool. Within a short time, partial blockage of the nozzle gap resulted in an inhomogeneous spray cone with gaps.

### Example 2

Recycling of sodium percarbonate dust into the fluidized bed buildup granulation.

The apparatus of example 1 was used to disperse 100 kg/h of sodium percarbonate dust from the offgas stream of a production plant for producing granular sodium percarbonate with a mean particle size of 45 μm into 280 l/h of 30% by weight soda solution, which were fed to a three-substance nozzle of the production plant. The three-substance nozzle was used to spray the resulting suspension, as well as 90 l/h of 44% by weight hydrogen peroxide, into the fluidized bed of the production plant using air as a propellant gas. During an operating time of 3 days, no increase in nozzle blockages was observed. From the mass balance of the plant, it was determined that more than 50% of the sodium percarbonate dust supplied had been incorporated into the granular sodium percarbonate produced. The recycling of sodium percarbonate dust had no effect on the particle size distribution and the abrasion resistance of the granular sodium percarbonate produced.

1-5. (canceled)

6. A process for producing granular sodium percarbonate by fluidized bed buildup granulation, comprising:
a) spraying an aqueous solution of hydrogen peroxide and an aqueous solution of sodium carbonate into a fluidized bed comprising sodium percarbonate particles, said spraying being performed using at least one multisubstance nozzle with external mixing, and
b) simultaneously evaporating water,
wherein said solution of sodium carbonate additionally comprises sodium carbonate and/or sodium percarbonate in suspended form and is passed through a dispersing apparatus for dispersion of solids before being fed to said multisubstance nozzle.

7. The process of claim 6, wherein said dispersing apparatus has mechanical action.

8. The process of claim 2, wherein said solution of sodium carbonate additionally comprising sodium carbonate and/or sodium percarbonate in suspended form is sheared between a rotor element and a stator element in said dispersing apparatus.

9. The process of claim 6, wherein solid sodium carbonate and/or solid sodium percarbonate is dispersed in an aqueous solution of sodium carbonate in said dispersing apparatus.

10. The process of claim 9, wherein sodium percarbonate is removed in the form of dust from an offgas stream of the fluidized bed and the removed dust is fed completely or partially to said dispersing apparatus.

11. The process of claim 6, wherein said solution of hydrogen peroxide has a hydrogen peroxide content of 30-75% by weight.

12. The process of claim 6, wherein said solution of hydrogen peroxide has a hydrogen peroxide content of 40-70% by weight.

13. The process of claim 11, wherein said solution of hydrogen peroxide further comprises one or more additives selected from the group consisting of: alkali metal silicates, magnesium salts, stannates, pyrophosphates, polyphosphates, and chelate complexing agents.

14. The process of claim 13, wherein said aqueous solution of sodium carbonate comprises one or more additives selected from the group consisting of: alkali metal silicates, magnesium salts, stannates, pyrophosphates, polyphosphates, and chelate complexing agents.

15. The process of claim 6, wherein said dispersing apparatus destroys agglomerates with a diameter which is more than one third of the minimum channel dimension of the said multisubstance nozzle.

16. The process of claim 6, wherein said hydrogen peroxide solution and said solution of sodium carbonate have flow rates through said multisubstance nozzel that give rise to a molar ratio of sodium carbonate to hydrogen peroxide in the range of 1:1.4 to 1:1.7 and wherein said molar ratio is based on the total amount of dissolved and suspended sodium carbonate, but does not include suspended sodium percarbonate.

17. The process of claim 16, wherein said molar ratio of sodium carbonate to hydrogen is in the range 1:1.5 to 1:1.65.

18. The process of claim 16, wherein said hydrogen peroxide solution and said solution of sodium carbonate are both at a temperature of 20-70° C.

19. The process of claim 18, wherein said solution of hydrogen peroxide has a hydrogen peroxide content of 30-75% by weight.

20. The process of claim 19, wherein said dispersing apparatus destroys agglomerates with a diameter which is more than one third of the minimum channel dimension of the said multisubstance nozzle.

21. The process of claim 20, wherein said solution of hydrogen peroxide further comprises one or more additives selected from the group consisting of: alkali metal silicates, magnesium salts, stannates, pyrophosphates, polyphosphates, and chelate complexing agents.

22. The process of claim 21, wherein said aqueous solution of sodium carbonate comprises one or more additives selected from the group consisting of: alkali metal silicates, magnesium salts, stannates, pyrophosphates, polyphosphates, and chelate complexing agents.

23. The process of claim 22, wherein sodium percarbonate is removed in the form of dust from an offgas stream of the fluidized bed and the removed dust is fed completely or partially to said dispersing apparatus.
